(19) United States
(12) Patent Application Publication
(10) Pub. No.: US 2008/0090209 A1
(43) Pub. Date: Apr. 17, 2008

(54) Dental implants using shape memory alloys

(76) Inventor: Alvin A. Snaper, Las Vegas, NV (US)

Correspondence Address: DONALD D. MON, SUITE 303, 750 EAST GREEN STREET, PASADENA, CA, 91101, US

(21) Appl. No.: 11/580,712

(22) Filed: Oct. 12, 2006

(51) Int. Cl. A61C 8/00

(52) U.S. Cl. 433/173

(57) ABSTRACT

A dental implant made from a memory shape-retaining alloy provided in an uniform shape that is converted to a set (remembered) shape after placement in a prepared cavity and appropriately heated, thereby to be positively retained in the cavity.

### FIELD OF THE INVENTION

Dental implants for implantation in a human jaw. The implant is made of an alloy having a shape memory. It's “set shape” is established prior to implantation and then formed to an “interim” shape for implantation. After insertion the implant is caused to revert from its interim shape to its set shape by appropriate application of heat to the implant while in place. When properly proportioned it exerts a continuing retentive force in the jaw.

### BACKGROUND OF THE INVENTION

Dental implants intended to serve as a root or anchor for a denture or tooth are well-known. Generally they rely on an initial tight fit of the implant in the bone and subsequent osseo-integration. The closer the fit, the better. Examples of such implants are shown in Robert H. Propper U.S. Pat. Nos. 5,004,422 and 5,419,701.

Placement of implants into the jaw is quite ancient, but until very modern times they were of only limited utility. Advances in dental tooling, appliances, materials of construction, and sanitation have enabled many novel approaches to be taken safely, and more recently quite successfully.

Generally the newer implants comprise a rigid body intended to fit closely in a prepared socket. The shape of the socket and of the implant are uniquely associated with one another. When first formed, the shapes of the implant and of the socket are established and are not changed. This places a significant constraint on the process.

For example, a conventional implant cannot be inserted into a cavity which enlarges as it deepens, such as an undercut to make a close fit, because of dimensional interference. There will be an increasing lateral gap when such an implant is inserted.

To avert this, an outwardly opening conical cavity can closely receive a mating conical implant, but there is an obvious reduction in side support from the jaw structure and greater reliance on osseo-integration and coatings for retention.

Further, with an implant of fixed dimensions, forces between the implant and jaw are limited to those which are exerted by the surgeon when he inserts the implant, and these generally relax afterward, because the implant and the socket are quite hard, and when the surgeon's forces are removed, the implant moves as it pleases, unless restrained adhesively or the fit is tight enough.

To overcome these problems, efforts have been made to utilize flat blades for the implant to be integrated. Often these blades are perforated to allow for subsequent ingrowth. Still, the only restraint on the implant resides in the tightness of fit of the rigid blade, and whatever adhesiveness or ingrowth that later occurs.

It is an object of this invention to provide an implant with an interim shape that can be inserted into a socket or slot in which it does not fit initially, and with a set shape to which it changes upon the suitable application of heat.

It is a further object of this invention to provide an implant which inherently exerts a continuing lateral force after implantation, even if undercut surfaces are not employed, thereby enjoying this advantage in simple slots.

### BRIEF DESCRIPTION OF THE INVENTION

The dental implant of this invention utilizes the inherent property of a shape memory alloy to revert to a “set” shape from an “interim” shape upon the application of suitable heat. The set shape is the intended shape of the implant after placement and the application of heat.

The interim shape is formed by application of physical force to form the material into a shape amenable to insertion into a recess of some kind, for example a slot, a socket, and an undercut slot or socket all hereafter referred to as a recess. After the implant in its interim shape is inserted (placed), appropriate heat is applied to it, and it reverts to its set shape which can thereby be seated in a cavity in which it might not otherwise have been able to be implanted and with proper dimensions until fit tightly in the implant.

Lateral extension of the implant structure, usually blade-like, is the preferred use. Other uses involve variations in the lateral dimensions of a leaf-like base, and of legs that have undulant or other irregular shapes. Whatever the shape, where the implant is appropriately shaped and sized relative to its implanted contiguous surfaces, it continues to exert its lateral force, thereby reducing or eliminating the tendency to loosen.

In use, the implant acts as a root. It can have an included post for an artificial tooth or denture, or include the tooth or denture as part of its own structure. It can also have an internally threaded socket of its own into which a next article can be threaded.

The above and other features of this invention will be fully understood from the following detailed description and the accompanying drawings, in which:

### BRIEF DESCRIPTION OF THE DRAWINGS

FIG. 1 is a plan view of the presently-preferred embodiment of the invention in its set condition;

FIG. 2 is a cross-section taken at line 2-2 in FIG. 1;

FIG. 3 is a cross-section taken at line 3-3 in FIG. 1;

FIG. 4 is an end view of the implant of FIG. 1 in its interim condition;

FIG. 5 is a cross-section showing a recess in the shape of a slot in the jaw in which the implant of FIG. 1 is to be inserted;

FIG. 6 is a cross-section showing the implant of FIG. 1 in its set condition, implanted in a jaw; and

FIG. 7 is a top schematic showing of another useful shape of an implant according to this invention.

### DETAILED DESCRIPTION OF THE INVENTION

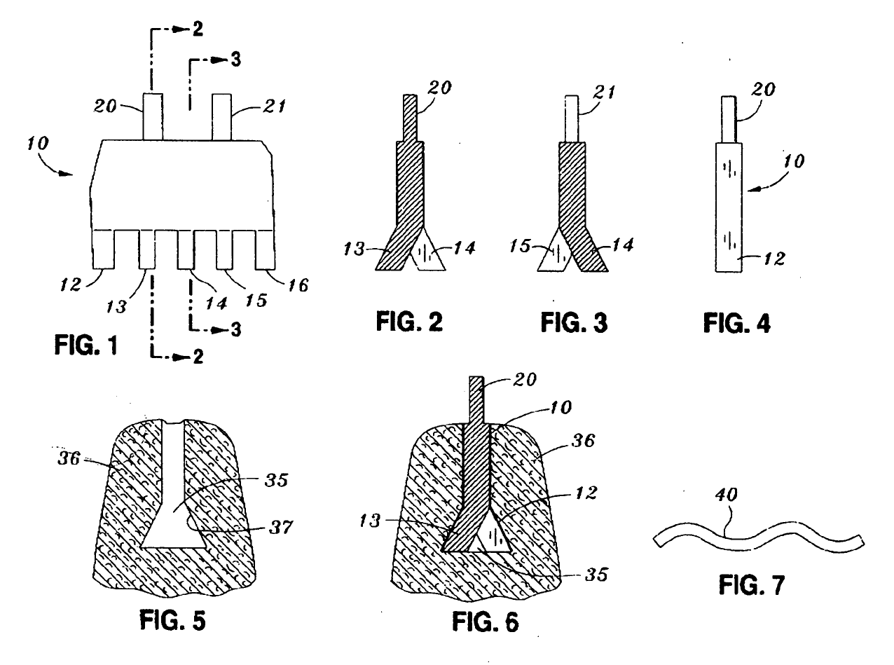

The preferred embodiment of this invention is shown in FIG. 1 in its set condition. This implant 10 includes a base 11 from which a plurality, in this example five, of legs 12,13,14,15,16. These legs depart from the base, and are integral with it at their upper ends. As will be discussed below, it is these legs which will principally be used to structurally retain the implant in a jaw.

The base and its legs may be used as a reinforcing structure, or more frequently as a root or base for other structures. In FIG. 1, a pair of teeth 20,21 are made integral with the base, and are intended to be shaped to some agreeable shape, or to serve as a post or core for one, such as an artificial tooth cemented to it. It may have any desired configuration.

In fact, the base may have drilled and threaded-taped holes in it so as to receive appurtenances such as teeth, brace wires, and whatever else may be of use.

The gist of this invention is its capacity to change the shape of the implant from its interim condition which enables it to be inserted into the jaw, to its set condition in which it is positively, structurally, retained in the jaw.

In FIG. 1, which shows the set condition, but outside of a jaw, the legs have been caused to depart from the plane of the base. FIGS. 2 and 3 illustrate the difference between legs 13 and 14, which depart from the plane of the base in opposite directions.

These could, if desired, both be inserted in the same socket or recess, but more often would be in a slot. For that matter, the base could extend a substantial distance away from any of them, and may have a set shape of its own, for example an arch.

FIG. 4 shows the implant in a simple interim condition, namely flat. This end view adequately illustrates it while FIG. 7 shows another base 36 with a set configuration that is serpentine. If desired, the side shapes of the implant could be dimpled or otherwise deviated from plane along its upward axis. The set shape is selected to be a final fit. The interim shape is for enabling the implant to be inserted into the slot or socket.

As shown in FIGS. 2 and 3, legs 13 and 14 depart from the plane in opposite directions, and can thereby cooperate to hold the implant in a jaw structure. FIG. 5 shows a recess 35 in a jaw 36 with an undercut 37 in a slot or recess 38 near or at its bottom. It is in its set condition that it could not have been directly inserted into the slot. The interim shape (which probably would be flat) can be inserted, as shown in FIG. 6.

FIG. 7 illustrates an implant 40 with another of the many set conditions which are available. The interim shape may be flat, curved, or otherwise, so long as it enables insertion of the implant while in the interim shape.

While any biocompatible alloy that exhibits suitable shape memory properties, perhaps the most completely studied and accepted is the alloy of Nickel and Titanium commercially available under the name Nitinol. This alloy is available with various transformation temperatures and temperature spans for the transformation of the alloy to or from heating from martensite to austenite, and cooling from austenite to martensite.

The basic process is to form a blank or other article to a desired set shape (sometimes called a “trained” shape). This is the ultimately desired configuration after implantation. It is formed to this shape, constrained to this shape and heat treated to permanently set the shape into the material. Then it is annealed and cooled.

It is then mechanically shaped to a desired interim shape such as by pressing. It retains this interim shape until heated to its transition temperature, upon which it will return to its set shape.

It is interesting and important that the entire implant need not be heated to the temperature that was needed to train the body to its set condition. Instead it has been found that a very brief and local burst of heat to some part of the implant can cause the entire implant to transform to the set condition.

Because these implants are intended to be placed in the mouth, the implant cannot be heated in its entirety to an elevated temperature. It has been found, however, that a very high, very local, application of heat can function for this purpose, and will not harm surrounding tissue.

For example, there exists a cordless soldering tool which applies two spaced-apart electrodes to a conductive metal surface and applies a voltage across them which produces a very hot local region in the workpiece. Often the workpiece is a solder. This is so efficient that it can be powered by four AA batteries. Still the heat for these implants needs to be applied only very locally and for such a short period of time that the highest temperature reached by the implant where it contacts tissue or bone remains well within tolerable limits.

The specific alloy to be used will be selected for the ability to transform it from its interim shape to a set shape by a brief local application of heat. Useful alloys, commonly referred to as Standard SMA Ni Ti alloys code S, C or M may be obtained from Johnson Matthey Company, San Jose, Calif.

Accordingly, in accordance with this invention, a blank form is shaped to a set shape while heated to a temperature above the transition temperature to austenite. Then it is annealed, cooled, and processed to a different interim shape in the martensite range of temperature. This interim shape will be retained until suitable heat is applied locally to start the transition back to martensite, when it returns to its set shape, the implant having been inserted while in the interim shape. When it is appropriately heated to resume its set shape, it retains the shape and is fixed in place.

It is an important feature that if some of the dimensions of the set condition are somewhat “oversize”, then when the implant is heated and the implant enlarges, but is restrained by surrounding structure such as the walls of a jaw, the implant will continue to exert a prevailing force tending to hold the implant in place. This greatly reduces the tendency of the implant to come loose. Of course the expansive force must not be so great as to crack surrounding bone, but this can readily be designed for.

This invention is not to be limited by the embodiments shown in the drawings and described in the description, which are given by way of example and not of limitation, but only in accordance with the scope of the appended claims.

I claim:

1. A dental implant comprised of a memory shape retaining alloy inherently able to be conformed to an interim shape of one crystal structure and later upon application of sufficient heat, to transform to an another crystal structure, and regain a previous set shape while it is in place in a cavity having a rigid wall, the surface configuration of the interim shape being such as can be directly inserted in said cavity, and the surface configuration of said set shape more closely fitting in said cavity after said transformation.

2. A dental implant according to claim 1 in which said set shape has at least one lateral dimension greater than the respective dimension of the implant when it was in the interim shape.

3. A dental implant according to claim 1 in which said implant includes a base with a plurality of integral legs, said legs while in the interim shape lying substantially parallel to each other, and when in said set shape, being outwardly bent, whereby said implant can be inserted into an undercut cavity while in said interim shape, and can be expanded to fit in said cavity when in said set shape.

4. In combination:
a bony dental structure having a cavity therein into which an implant is to be placed and thereafter remain in place; and
a dental implant comprised of a memory shape retaining alloy inherently able to be conformed to an interim shape of one crystal structure and later upon application of sufficient heat, to transform to an another crystal structure, and regain a previous set shape while it is in place in a cavity having a rigid wall, the surface configuration of the interim shape being such as can be directly inserted in said cavity, and the surface configuration of said set shape more closely fitting in said cavity after said transformation.

5. A combination according to claim 4 in which said set shape has at least one lateral dimension greater than the respective dimension of the implant when it was in the interim shape.

6. A combination according to claim 5 in which said lateral dimension is related to the wall of the cavity such that the implant makes a tight fit, and exerts a prevailing retentive force against said wall.

7. A combination according to claim 5 in which said implant includes a base with a plurality of integral legs, said legs while in the interim shape lying substantially parallel to each other, and when in said set shape, being outwardly, whereby said implant can be inserted into an undercut cavity while in said interim shape, and can be expanded to fit in said cavity when in said set shape.
